(19) United States
(12) Patent Application Publication
(10) Pub. No.: US 2026/0299469 A1
(43) Pub. Date: Oct. 1, 2026

(54) FIXING DEVICE AND IMAGE FORMING APPARATUS

(71) Applicant: FUJIFILM Business Innovation Corp., Tokyo (JP)

(72) Inventors: Shingo AKIYAMA, Kanagawa (JP); Takashi OHASHI, Kanagawa (JP); Shogo KAMIYA, Kanagawa (JP); Kotaro ARAKI, Kanagawa (JP)

(73) Assignee: FUJIFILM Business Innovation Corp., Tokyo (JP)

(21) Appl. No.: 19/283,145

(22) Filed: Jul. 28, 2025

(30) Foreign Application Priority Data
Mar. 25, 2025 (JP) 2025-050524

(51) Int. Cl. G03G 15/20

(52) U.S. Cl. CPC G03G 15/2028; G03G 15/2032; G03G 15/2064; G03G 2215/2038

(57) ABSTRACT

A fixing device includes a first fixing section that has an endless section that rotates, a support section which is disposed to correspond to a fixing region through which a medium passes and which supports the endless section, and a heating section which heats the fixing region to increase a temperature of the fixing region to a fixing temperature determined in advance, a second fixing section that has a facing section which is pressed against the support section with the endless section nipped between the facing section and the support section in the fixing region, a peeling section that is disposed on a downstream side of the fixing region in a transport direction of the medium and that peels off the medium from the endless section, a changing section that changes a support position of the support section for the endless section according to a type of the medium, and a moving section that moves the peeling section in accordance with a movement of the support section.

### CROSS-REFERENCE TO RELATED APPLICATIONS

This application is based on and claims priority under 35 USC 119 from Japanese Patent Application No. 2025-050524 filed Mar. 25, 2025.

### BACKGROUND

### (i) Technical Field

The present invention relates to a fixing device and an image forming apparatus.

### (ii) Related Art

Techniques disclosed in JP2023-147160A ([0011] to [0014] and FIG. 1), JP2019-028278A ([0018], [0027] to [0037], and FIGS. 2 and 3), and JP2012-118339A ([0022] to [0044] and FIGS. 1 to 6) to be described below are well known with regard to a fixing device that heats and fixes an unfixed image on a surface of a medium in an image forming apparatus.

JP2023-147160A ([0011] to [0014] and FIG. 1) describes a fixing device in which first pressurizing means (1) and second pressurizing means (2) are disposed to face each other with a belt member (6) nipped therebetween. In JP2023-147160A ([0011] to [0014] and FIG. 1), the second pressurizing means (2) is moved by contact region movable means (3) according to a thickness of a medium (S) passing between the belt member (6) and the second pressurizing means (2) and a width dimension of a contact region (CN) is changed.

JP2019-028278A ([0018], [0027] to [0037], and FIGS. 2 and 3) describes a fixing device in which a fixing pad (405) and a pressurizing roller (402) are disposed to face each other with a fixing belt (401) nipped therebetween. In JP2019-028278A ([0018], [0027] to [0037], and FIGS. 2 and 3), a separation roller (409) is brought into contact with the fixing belt (401) from the outside according to the thickness of a sheet. An angle of the fixing belt (401) at an outlet of a fixing nip portion (N) is changed by the contact with the separation roller (409), and peelability of the sheet is changed.

JP2012-118339A ([0022] to [0044] and FIGS. 1 to 6) describes a fixing device in which a pressing pad (63) and a pressurizing roll (61) are disposed to face each other with a fixing belt (62) nipped therebetween. In JP2012-118339A ([0022] to [0044] and FIGS. 1 to 6), a disk cam (61C) is rotated to change a nip pressure of the nip portion (N) according to the thickness of the sheet. In addition, the pressing pad (63) is rotated in accordance with the change in the nip pressure to adjust the length of the unpressurized region to be within a certain range.

### SUMMARY

Aspects of non-limiting embodiments of the present disclosure relate to a fixing device and an image forming apparatus that suppress a decrease in peelability in a case where a support section that supports an endless section is moved according to a type of a medium in a fixing device in which the support section is disposed to correspond to a fixing region, compared to a case where a peeling section that peels off the medium, which has passed through the fixing region, from the endless section is fixed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, in order to address the technical problem, there is provided a fixing device including a first fixing section that has an endless section that rotates, a support section which is disposed to correspond to a fixing region through which a medium passes and which supports the endless section, and a heating section which heats the fixing region to increase a temperature of the fixing region to a fixing temperature determined in advance, a second fixing section that has a facing section which is pressed against the support section with the endless section nipped between the facing section and the support section in the fixing region, a peeling section that is disposed on a downstream side of the fixing region in a transport direction of the medium and that peels off the medium from the endless section, a changing section that changes a support position of the support section for the endless section according to a type of the medium, and a moving section that moves the peeling section in accordance with a movement of the support section.

### BRIEF DESCRIPTION OF THE DRAWINGS

Exemplary embodiment(s) of the present invention will be described in detail based on the following figures, wherein:

FIG. 1 is an overall explanatory view of an image forming apparatus according to Example 1 of the present invention;

FIG. 2 is an enlarged view of a fixing device of Example 1;

FIG. 3 is an enlarged view of a major part of a portion of a peeling section of Example 1;

FIG. 4 is an enlarged view of a major part of a fixing device of Example 2 and is a view corresponding to FIG. 3 of Example 1;

FIG. 5 is an enlarged view of a major part of a fixing device of Example 3 and is a view corresponding to FIG. 3 of Example 1;

FIG. 6 is an enlarged view of a major part of a fixing device of Example 4 and is a view corresponding to FIG. 3 of Example 1; and

FIG. 7 is an enlarged view of a major part of a fixing device of Example 5 and is a view corresponding to FIG. 3 of Example 1.

### DETAILED DESCRIPTION

Examples as specific examples of an exemplary embodiment of the present invention will be described below with reference to the drawings, but the present invention is not limited to Examples to be described below.

In order to facilitate the understanding of the following description, in the drawings, a front-rear direction will be referred to as an X-axis direction, a right-left direction will be referred to as a Y-axis direction, and an up-down direction will be referred to as a Z-axis direction. Directions or sides indicated by arrows X, −X, Y, −Y, Z, and −Z will be defined as a forward direction, a rearward direction, a rightward direction, a leftward direction, an upward direction, and a downward direction, or a front side, a rear side, a right side, a left side, an upper side, and a lower side, respectively.

In addition, in the drawings, a symbol “○” with a symbol “·” therein means an arrow from the back of the plane of the sheet to the front thereof and a symbol “○” with a symbol “x” therein means an arrow from the front of the plane of the sheet to the back thereof.

In the following description using the drawings, members other than members required for description will be omitted as appropriate to facilitate understanding.

### EXAMPLE 1

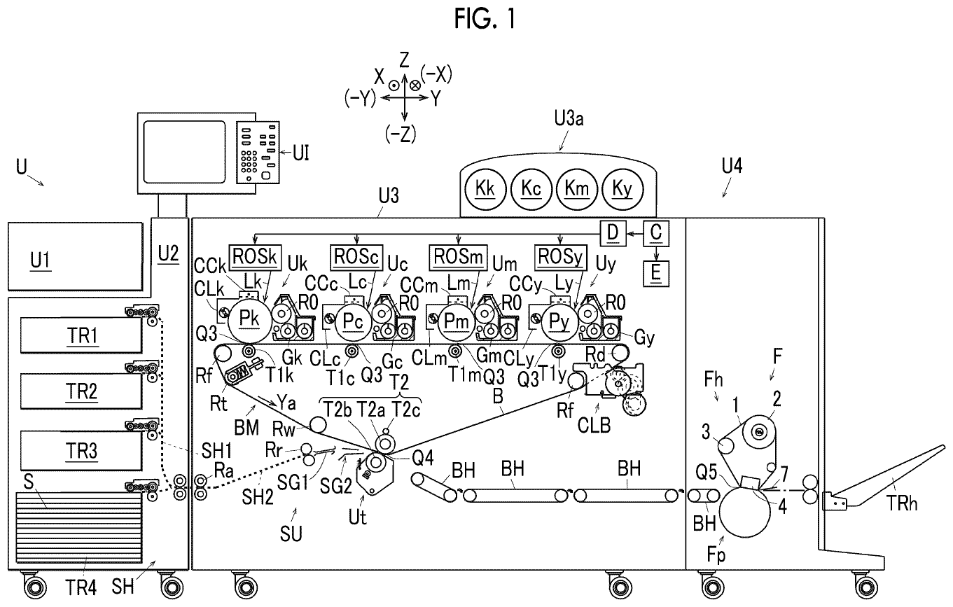

FIG. 1 is an overall explanatory view of an image forming apparatus according to Example 1 of the present invention.

In FIG. 1, a copying machine U that is an example of an image forming apparatus has a user interface UI that is an example of an operation unit, a scanner device U1 that is an example of an image reading device, a sheet feeding device U2, a printer unit U3 that is an example of image recording means, and a sheet discharge unit U4.

The user interface UI has a power button or a copy start key, a number-of-copies setting key, a numeric keypad, and the like as examples of an input unit, a display unit, and the like.

The scanner device U1 reads a document (not shown) to converts the read document into image information and inputs the image information to the printer unit U3.

The sheet feeding device U2 has a plurality of sheet feeding trays TR1, TR2, TR3, and TR4 which are examples of a sheet feed unit. Recording sheets S which are examples of a medium are accommodated in each of the sheet feeding trays TR1 to TR4. A sheet feeding passage SH1 which is an example of a transport passage for the medium extends from each of the sheet feeding trays TR1 to TR4 toward the printer unit U3.

In FIG. 1, the printer unit U3 has a control unit C that is an example of control means, a power source circuit E that supplies power to each member of the printer unit U3, and the like. The control unit C receives image information of a document read by the scanner device U1 and image information transmitted from a personal computer that is an example of an information transmission device (not shown) connected to the copying machine U.

The control unit C processes the received image information into yellow (Y), magenta (M), cyan (C), and black (K) printing information and outputs the processed image information to a laser drive circuit D that is an example of a drive circuit of a latent image writing device. The laser drive circuit D outputs a laser drive signal, which is input from the control unit C, to exposure devices ROSy, ROSm, ROSc, and ROSk that are examples of latent image forming means for each color at a time set in advance.

Image holder units Uy, Um, Uc, and Uk for Y, M, C, and K are disposed below the exposure devices ROSy to ROSk, respectively.

In FIG. 1, the image holder unit Uk for black (K) has a photoreceptor drum Pk that is an example of an image holding section, a charging corotron CCk that is an example of charging means, and a photoreceptor cleaner CLk that is an example of cleaning means for the image holding section. The image holder units Uy, Um, and Uc for the other colors Y, M, and C also have photoreceptor drums Py, Pm, and Pc, charging corotrons CCy, CCm, and CCc, and photoreceptor cleaners CLy, CLm, and CLc.

In Example 1, the photoreceptor drum Pk for a color of K, of which frequency of use is high and a surface is to be more worn, is configured to have a large diameter compared to diameters of the photoreceptor drums Py, Pm, and Pc for the other colors, so that response to high-speed rotation and a long service life are achieved.

After the photoreceptor drums Py to Pk are uniformly charged by the charging corotrons CCy to CCk, respectively, electrostatic latent images are formed on surfaces of the photoreceptor drums Py to Pk by laser beams Ly, Lm, Lc, and Lk which are examples of latent image writing light output from the exposure devices ROSy to ROSk. The electrostatic latent images on the surfaces of the photoreceptor drums Py to Pk are developed into toner images having the respective colors, that is, yellow (Y), magenta (M), cyan (C), and black (K) by developing devices Gy, Gm, Gc, and Gk which are examples of developing means.

The toner images on the surfaces of the photoreceptor drums Py to Pk are sequentially superimposed and transferred onto an intermediate transfer belt B, which is an example of an intermediate transfer section and an example of the image holding section, by primary transfer rolls T1y, T1m, T1c, and T1k, which is an example of a primary transfer section, in a primary transfer region Q3 so that a multicolor image, that is, a so-called color image is formed on the intermediate transfer belt B. The color image formed on the intermediate transfer belt B is transported to a secondary transfer region Q4.

In a case of only black image data, only the photoreceptor drum Pk and the developing device Gk for black (K) are used and only a black toner image is formed.

After the primary transfer, residual toner remaining on the surfaces of the photoreceptor drums Py to Pk is cleaned off by the photoreceptor cleaners CLy to CLk.

Each of the image holder units Uy to Uk and each of the developing devices Gy to Gk constitute a toner image forming member which is an example of image forming means.

A toner dispenser U3a that is an example of replenishment means is disposed on an upper portion of the printer unit U3, and toner cartridges Ky, Km, Kc, and Kk which are examples of developer accommodating means are attachably and detachably mounted on the toner dispenser U3a. In a case where toner is consumed in the developing devices Gy to Gk as images are formed, toner is supplied to each of the developing devices Gy to Gk from each of the toner cartridges Ky to Kk.

The intermediate transfer belt B disposed below the photoreceptor drums Py to Pk is stretched by an intermediate drive roll Rd that is an example of drive means for the intermediate transfer section, an intermediate tension roll Rt that is an example of tension application means which applies tension to the intermediate transfer belt B, an intermediate steering roll Rw that is an example of first bias correction means that corrects bias or meandering of the intermediate transfer belt B, a plurality of intermediate idler rolls Rf that are examples of driven means, and a backup roll T2a that is an example of a facing section of the secondary transfer region. The intermediate transfer belt B is supported to be rotatably movable in a direction of an arrow Ya by being driven by the intermediate drive roll Rd.

A belt module BM that is an example of an intermediate transfer device is configured by the intermediate drive roll Rd, the intermediate tension roll Rt, the intermediate steering roll Rw, the intermediate idler roll Rf, the backup roll T2a, the primary transfer rolls T1y to T1k, the intermediate transfer belt B, and the like. The belt module BM of Example 1 is configured by a unit that is attachable to and detachable from the printer unit U3 or is replaceable in the printer unit U3.

A secondary transfer unit Ut that is an example of transfer and transport means is disposed below the backup roll T2a. The secondary transfer unit Ut has a secondary transfer roll T2b that is an example of a transfer member. The secondary transfer roll T2b is disposed to face the backup roll T2a. The secondary transfer region Q4 is configured by a region where the secondary transfer roll T2b faces the intermediate transfer belt B. In addition, a contact roll T2c that is an example of contact means for voltage application is in contact with the backup roll T2a. A secondary transfer voltage having the same polarity as a charging polarity of toner is applied to the contact roll T2c from the power source circuit E controlled by the control unit C at a time set in advance.

A secondary transfer device T2 that is an example of a secondary transfer section is configured by the respective rolls T2a to T2c. In addition, a transfer device B+T1+T2 that is an example of a transfer section is configured by the intermediate transfer belt B, the primary transfer rolls T1y to T1k, the secondary transfer device T2, and the like.

A sheet transport passage SH2 is disposed below the belt module BM. The recording sheet S fed from the sheet feeding passage SH1 of the sheet feeding device U2 is transported to the sheet transport passage SH2 by a transport roll Ra that is an example of transport means. The recording sheet S in the sheet transport passage SH2 is fed by a registration roll Rr that is an example of feeding means according to a time when a toner image is transported to the secondary transfer region Q4, is guided by sheet guides SG1 and SG2 that are examples of medium guide means, and is transported to the secondary transfer region Q4.

The toner image on the intermediate transfer belt B is transferred onto the recording sheet S by the secondary transfer device T2 when passing through the secondary transfer region Q4. In a case of a color image, toner images superimposed and primarily transferred onto the surface of the intermediate transfer belt B are collectively and secondarily transferred onto the recording sheet S.

The intermediate transfer belt B after the secondary transfer is cleaned by a belt cleaner CLB that is an example of cleaning means of the intermediate transfer section.

The recording sheet S to which a toner image is secondarily transferred is sent to a medium transport belt BH that is an example of the transport means. The medium transport belt BH transports the recording sheet S to a fixing device F that is an example of a belt unit and an example of a fixing section. The fixing device F has a heating unit Fh that is an example of a first fixing section and a pressurizing unit Fp that is an example of a second fixing section. A fixing region Q5 is formed of a region where the heating unit Fh and the pressurizing unit Fp face each other and are in contact with each other.

The toner image on the recording sheet S is heated and fixed by the fixing device F when passing through the fixing region Q5. The recording sheet S to which the toner image is fixed by the fixing device F is discharged to a discharge tray TRh that is an example of a discharge unit.

A sheet transport passage SH is configured by reference numerals SH1, SH2, and the like. In addition, a sheet transport device SU is configured by reference numerals SH, Ra, Rr, SG1, SG2, BH, and the like.

### Description of Fixing Device

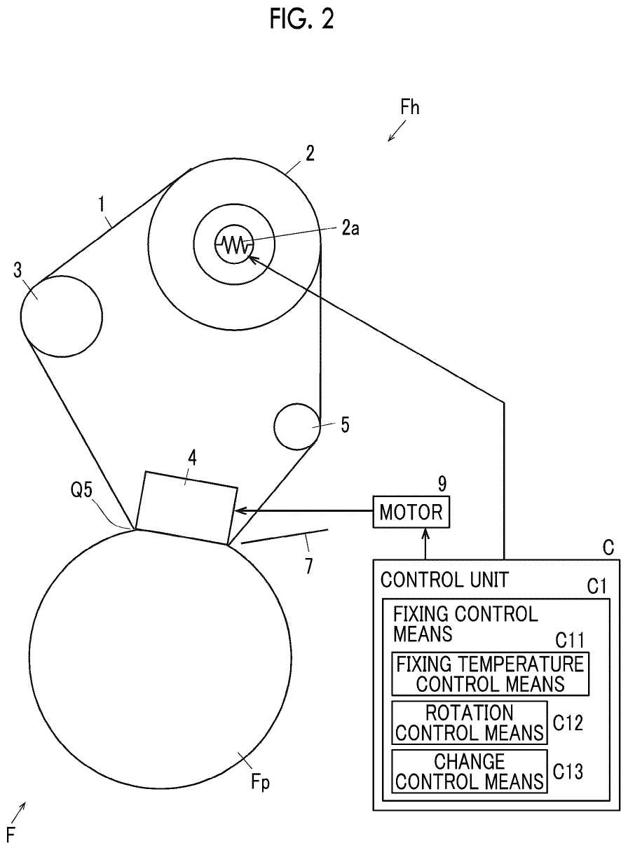

FIG. 2 is an enlarged view of the fixing device of Example 1.

In FIG. 1, the heating unit Fh of the fixing device F of Example 1 has a fixing belt 1 that is an example of an endless section. The fixing belt 1 is stretched by a heating roll 2 that is an example of a heating section, a steering roll 3 that is an example of bias correction means, a heating pad 4 that is an example of a support section, and a tension roll 5 that is an example of the tension application means.

The fixing belt 1 can be made of any well-known material in the related art, and it is preferable that a substrate thereof is made of, for example, a polyimide-based material having high stiffness. In addition, it is preferable that a surface layer of the fixing belt 1 is made of, for example, a material such as a fluororesin having high releasability of molten toner, paper powder, or the like.

A heater 2a that is an example of the heating section is built in the heating roll 2 of Example 1. The heating roll 2 heated by the heater 2a heats the fixing belt 1 that is in contact therewith.

The steering roll 3 corrects the meandering or bias of the fixing belt 1.

The heating pad 4 is disposed to face a pressurizing roll 6 of the pressurizing unit Fp. The fixing region Q5 is configured by a region between the fixing belt 1 supported by the heating pad 4 and the pressurizing roll 6 that is an example of the facing section. Accordingly, unfixed images on the recording sheet S passing through the fixing region Q5 are fixed to the recording sheet S by being pressurized while being heated.

The tension roll 5 applies tension to the fixing belt 1.

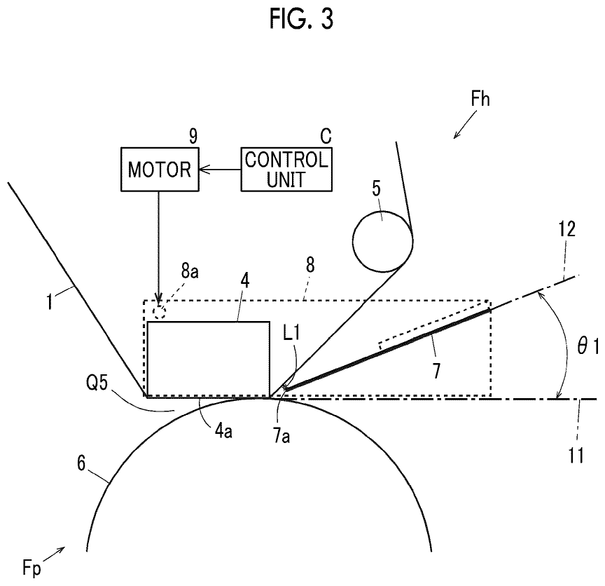

FIG. 3 is an enlarged view of a major part of a portion of a peeling section of Example 1.

A peeling baffle 7 that is an example of the peeling section is disposed on a downstream side of the fixing region Q5 with respect to a sheet transport direction. The peeling baffle 7 of Example 1 is formed in a flat plate shape. A tip portion 7a of the peeling baffle 7 is disposed close to an outer surface of the fixing belt 1 on an outlet side of the fixing region Q5. In FIG. 3, in Example 1, an interval between the tip portion 7a of the peeling baffle 7 on a fixing region Q5 side and the fixing belt 1 is set to an interval L1 determined in advance. In addition, an angle formed by an extension line 11 of a surface 4a of the heating pad 4 forming the fixing region Q5 and an extension line 12 of the peeling baffle 7 is set to an angle θ1 determined in advance. The interval L1 and the angle θ1 are derived in advance by an experiment or the like related to peelability of the recording sheet S. Therefore, the peeling baffle 7 can peel off the recording sheet S attached to the fixing belt 1 after passing through the fixing region Q5.

In Example 1, the heating pad 4 and the peeling baffle 7 are supported by a movable bracket 8 that is an example of moving support means at both end parts of the heating pad 4 in an axial direction (front-rear direction). The movable bracket 8 of Example 1 is supported to be rotatable about a rotation center 8a. Therefore, in Example 1, the heating pad 4 and the peeling baffle 7 are integrally rotatably movable together with the common movable bracket 8.

The movable bracket 8 is rotatably movable as driving from a motor 9 that is an example of a driving source via a drive transmission system such as a gear (not shown). Therefore, the movable bracket 8 of Example 1 has both a function as a changing section that changes the position of the heating pad 4 and a function as a moving section that moves the peeling baffle 7 according to the movement of the heating pad 4. That is, the movable bracket 8 of Example 1 serves as both the changing section and the moving section.

The heating unit Fh of Example 1 is configured by the fixing belt 1, the heating roll 2, the steering roll 3, the heating pad 4, the tension roll 5, the peeling baffle 7, the movable bracket 8, the motor 9, a spring that presses the tension roll 5 (not shown), and the like, which are shown in the drawing.

In addition, the pressurizing unit Fp of Example 1 is configured by the pressurizing roll 6, a spring (not shown) that presses the pressurizing roll 6 toward the heating pad 4, and the like.

### Description of Control Unit of Example 1

In FIG. 2, the control unit (controller) C of the copying machine U has an input/output interface I/O that inputs and outputs signals to and from the outside. In addition, the control unit C has a read-only memory (ROM) in which a program, information, and the like for necessary processing are stored. In addition, the control unit C has a random access memory (RAM) that temporarily stores necessary data. In addition, the control unit C has a central processing unit (CPU) that performs processing corresponding to the program stored in the ROM or the like. Therefore, the control unit C of Example 1 is configured by a small information processing device, that is, a so-called microcomputer. Accordingly, the control unit C can realize various functions by executing the program stored in the ROM or the like.

Signals from a signal output element are input to the control unit C of Example 1, and the control unit C performs control by outputting the signals to a control target element.

### Functions of Control Unit C

The control unit C of Example 1 has the following functional means (functional modules, program modules).

Fixing control means C1 has fixing temperature control means C11, rotation control means C12, and change control means C13. The fixing control means C1 controls the operation and stop of the fixing device F.

The fixing temperature control means C11 controls ON/OFF of the heater 2a to maintain the temperature of the fixing belt 1 at a fixing temperature determined in advance. The fixing temperature control means C11 starts the control of the heater 2a such that the temperature reaches the fixing temperature in a case where a job, which is an image forming operation, is started. In a case where the job ends, the fixing temperature control means C11 turns off the heater 2a.

The rotation control means C12 controls the rotation of the pressurizing roll 6. Therefore, the rotation of the fixing belt 1 to be driven and rotated is also indirectly controlled with the rotation of the pressurizing roll 6. The rotation control means C12 of Example 1 drives the pressurizing roll 6 in a case where the job is started, and stops the pressurizing roll 6 in a case where the job ends. In Example 1, an aspect in which the pressurizing roll 6 is driven and the fixing belt 1 is driven and rotated has been described as an example, but the present invention is not limited thereto. For example, an aspect in which the heating roll 2 is driven and a pressurizing roll 6 side is driven and rotated can also be adopted.

The change control means C13 controls the motor 9 to change the positions of the heating pad 4 and the peeling baffle 7. The change control means C13 of Example 1 moves the movable bracket 8 to change the positions of the heating pad 4 and the peeling baffle 7 according to the type of the recording sheet S, that is, thick paper, thin paper, plain paper, or the like. For example, with the position in a case of the plain paper as reference, in the case of the thick paper, the position is moved such that a range where the pressure is high (nip region) is wider than the range of the plain paper, and in the case of the thin paper, the position is moved such that the range where the pressure is high is narrower than the range of the plain paper.

### Action of Example 1

In the fixing device F of Example 1 having the configuration, the position of the heating pad 4 is adjusted according to the type of the recording sheet S. In this case, the peeling baffle 7 and the movable bracket 8 also move integrally with the movement of the heating pad 4. Therefore, the interval L1 and the angle θ1 are maintained before and after the movement of the heating pad 4.

In the techniques described in JP2023-147160A ([0011] to [0014] and FIG. 1), JP2019-028278A ([0018], [0027] to [0037], and FIGS. 2 and 3), and JP2012-118339A ([0022] to [0044] and FIGS. 1 to 6), peelability is ensured by changing the posture of the belt, and second pressurizing means (2), a separation roller (409), and a pressing pad (63) are moved. Therefore, there is no member (peeling section) corresponding to the peeling baffle 7, and in a case where the member corresponding to the peeling baffle 7 is present and the peeling section is fixed, one or both of the interval L1 and the angle θ1 change. Therefore, a peeling performance of the peeling section may change, and peeling failure may occur.

On the other hand, in Example 1, the peeling baffle 7 also moves with the movement of the heating pad 4. Therefore, before and after the movement, a positional relationship between the heating pad 4 and the peeling baffle 7 is maintained, and the interval L1 and the angle θ1 are maintained. Accordingly, in the fixing device F in which the heating pad 4 that supports the fixing belt 1 is disposed to correspond to the fixing region Q5, in a case where the heating pad 4 is moved according to the type of the recording sheet S, a decrease in the peelability is suppressed compared to a case where the peeling baffle 7 that peels off the recording sheet S, which has passed through the fixing region Q5, from the fixing belt 1 is fixed.

### EXAMPLE 2

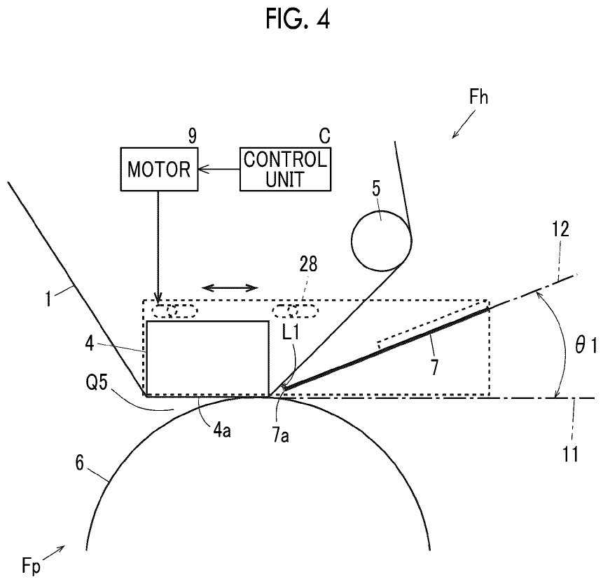

FIG. 4 is an enlarged view of a major part of a fixing device of Example 2 and is a view corresponding to FIG. 3 of Example 1.

Next, Example 2 of the present invention will be described. The components that are the same components in Example 1 will be denoted by the identical reference numerals, and detailed description thereof will be omitted.

In FIG. 4, a movable bracket 28 of Example 2 is supported to be movable, that is, to be slidably movable and to be movable in parallel along a medium transport direction, unlike the movable bracket 8 of Example 1.

Therefore, even in the fixing device F of Example 2, the positional relationship between the heating pad 4 and the peeling baffle 7 is maintained during the movement of the heating pad 4, and the interval L1 and the angle θ1 are maintained. Accordingly, a decrease in peelability is suppressed compared to a case where the peeling baffle 7 is fixed.

### EXAMPLE 3

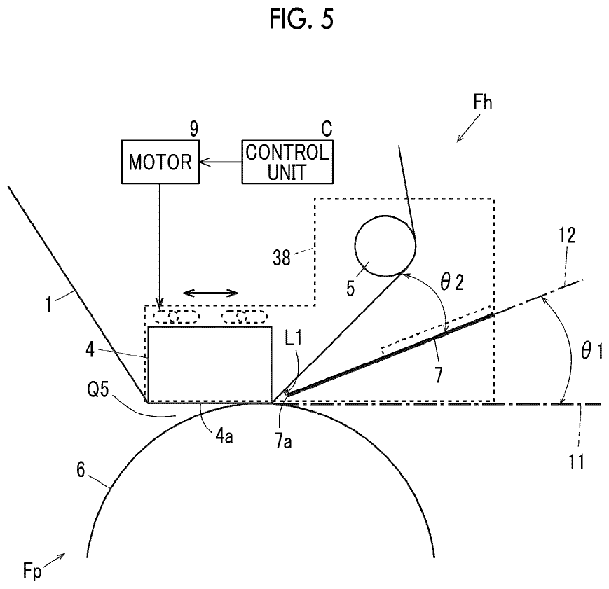

FIG. 5 is an enlarged view of a major part of a fixing device of Example 3 and is a view corresponding to FIG. 3 of Example 1.

Next, Example 3 of the present invention will be described. The components that are the same components in Examples 1 and 2 will be denoted by the identical reference numerals, and detailed description thereof will be omitted.

In FIG. 5, a movable bracket 38 of Example 3 also supports the tension roll 5 that is an example of a second support section, in addition to the heating pad 4 and the peeling baffle 7. In Example 3, the movable bracket 38 supports the heating pad 4, the peeling baffle 7, and the tension roll 5 such that an angle formed by the surface of the fixing belt 1 between the heating pad 4 and the tension roll 5 and the extension line 12 of the peeling baffle 7 is an angle θ2 determined in advance.

In the fixing device F of Example 3 having the configuration, in a case where the heating pad 4 is moved according to the type of the recording sheet S, the peeling baffle 7 and the tension roll 5 are also integrally moved. Therefore, a positional relationship between the heating pad 4, the peeling baffle 7, and the tension roll 5 is maintained, and the positional relationship between the surface of the fixing belt 1 between the heating pad 4 and the tension roll 5 and the peeling baffle 7 is also maintained. Therefore, not only the interval L1 and the angle θ1, but also the angle θ2 is maintained before and after the movement of the heating pad 4. Therefore, a decrease in peelability is further suppressed compared to a case where the angle θ2 is not maintained.

In Example 3, an aspect in which the heating pad 4 or the like is slidably moved has been described as in Example 2, but the aspect in which the heating pad 4 or the like is rotationally moved as in Example 1 can also be applied.

### EXAMPLE 4

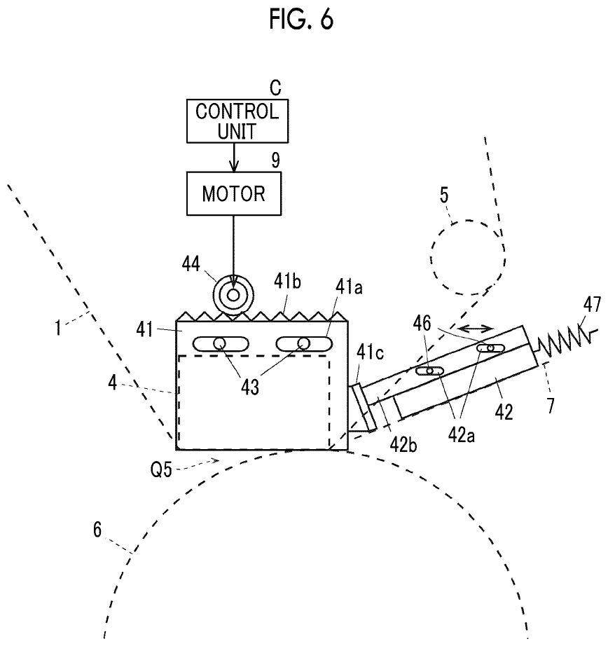

FIG. 6 is an enlarged view of a major part of a fixing device of Example 4 and is a view corresponding to FIG. 3 of Example 1.

Next, Example 4 of the present invention will be described. The components that are the same components in Examples 1 and 2 will be denoted by the identical reference numerals, and detailed description thereof will be omitted.

In FIG. 6, the fixing device F of Example 4 has a pad support bracket 41 that is an example of the changing section and a baffle bracket 42 that is an example of the moving section, unlike the movable bracket 8 of the changing section and the moving section of Example 1. The pad support bracket 41 supports the heating pad 4. A guide hole 41a that is an example of guided means is formed in the pad support bracket 41. A guide pin 43 supported by a frame of the fixing device F passes through the guide hole 41a. Therefore, the pad support bracket 41 is supported to be slidably movable along the medium transport direction, as in Example 2. In addition, a rack tooth 41b that is an example of driven means is formed on the pad support bracket 41. A pinion gear 44 is engaged with the rack tooth 41b. Driving is transmitted from the motor 9 to the pinion gear 44. Therefore, the pad support bracket 41 is slidably moved by driving the motor 9. In addition, the pad support bracket 41 is formed with a pressed portion 41c.

The baffle bracket 42 supports the peeling baffle 7. A guide hole 42a that is an example of the guided means is formed in the baffle bracket 42. A guide pin 46 supported by the frame of the fixing device F passes through the guide hole 42a. Therefore, the baffle bracket 42 is slidably movable, like the pad support bracket 41.

The baffle bracket 42 is formed with a pressing portion 42b that comes into contact with the pressed portion 41c. In addition, a spring 47 that is an example of a biasing section is connected to the baffle bracket 42. The spring 47 applies an elastic force in a direction in which the pressing portion 42b is pressed against the pressed portion 41c.

In the fixing device F of Example 4 having the configuration, in a case where the motor 9 is driven according to the type of the recording sheet S, the pad support bracket 41 is moved and the heating pad 4 is moved. In this case, the pressed portion 41c is also moved, and the baffle bracket 42 in which the pressing portion 42b is in contact with the pressed portion 41c is also moved. Accordingly, the peeling baffle 7 is moved in conjunction with the movement of the heating pad 4. Therefore, even in Example 4, the positional relationship between the heating pad 4 and the peeling baffle 7 is maintained during the movement of the heating pad 4, and the interval L1 and the angle θ1 are maintained. Accordingly, a decrease in peelability is suppressed compared to a case where the peeling baffle 7 is fixed.

### EXAMPLE 5

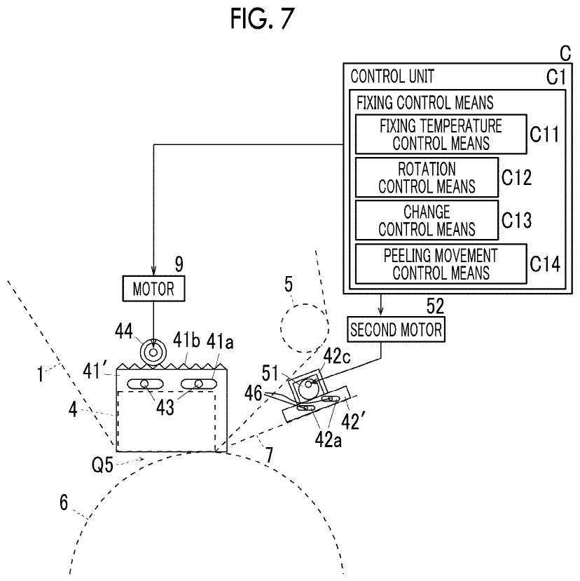

FIG. 7 is an enlarged view of a major part of a fixing device of Example 5 and is a view corresponding to FIG. 3 of Example 1.

Next, Example 5 of the present invention will be described. The components that are the same components in Examples 1, 2, and 4 will be denoted by the identical reference numerals, and detailed description thereof will be omitted.

In FIG. 7, the fixing device F of Example 5 has a pad support bracket 41′ that is an example of the changing section and a baffle bracket 42′ that is an example of the moving section, as in Example 4.

The pad support bracket 41′ of Example 5 is different from the pad support bracket 41 of Example 4 in that the pressed portion 41c is not provided.

The baffle bracket 42′ of Example 5 does not have the pressing portion 42b compared to the baffle bracket 42 of Example 4. In addition, the baffle bracket 42′ of Example 5 is formed with a cam follower portion 42c that is an example of the driven means. An eccentric cam 51 that is an example of the drive means is accommodated in the cam follower portion 42c. Driving is transmitted from a second motor 52 to the eccentric cam 51. The second motor 52 is driven by receiving a control signal from peeling movement control means C14 of the control unit C.

The peeling movement control means C14 controls the rotation of the second motor 52 in accordance with the control of the motor 9 by the change control means C13. The peeling movement control means C14 controls a movement amount of the peeling baffle 7 such that the interval L1 and the angle θ1 are maintained according to the movement amount of the heating pad 4 with the movement of the motor 9.

In the fixing device F of Example 5 having the configuration, the heating pad 4 is moved by driving of the motor 9, and the peeling baffle 7 is moved by driving of the second motor 52. That is, the heating pad 4 and the peeling baffle 7 are movable separately and independently of each other. Therefore, the heating pad 4 and the peeling baffle 7 are moved such that the interval L1 and the angle θ1 are maintained. Accordingly, in a case where the movement amount of the heating pad 4 and the movement amount of the peeling baffle 7 are required to be different from each other with the interval L1 and the angle θ1 maintained, control is performed independently of each other in a manner that the movement amounts are different. Therefore, in a case where the interval L1 and the angle θ1 are not maintained in response to a case where the heating pad 4 and the peeling baffle 7 move integrally or in conjunction with each other due to configurations of members or a constraint on a movement direction, the interval L1 and the angle θ1 can be maintained by moving the heating pad 4 and the peeling baffle 7 separately as in Example 5. Therefore, a degree of freedom in the design of the positions, sizes, movement directions, and the like of the heating pad 4 and the peeling baffle 7 is improved compared to a case where the movement amounts are constrained in an identical manner.

### MODIFICATION EXAMPLES

The Examples of the present invention has been described in detail above, but the present invention is not limited to the Examples described above and can have various modifications without departing from the scope of the present invention described in claims. Modification Examples (H01) to (H06) of the present invention will be given as examples below.
(H01) The copying machine U that is an example of the image forming apparatus has been given as an example in the Examples described above, but without being limited thereto, for example, the image forming apparatus can also be configured by a FAX, a printer, and a multifunction machine.
(H02) A configuration where developers for four colors are used has been given as an example of the image forming apparatus in the Example described above, but without being limited thereto, for example, the present invention can also be applied to a monochromatic image forming apparatus and an image forming apparatus for multiple colors of three colors or less or five colors or more.
(H03) In the Examples, the shape of the heating pad 4 is not limited to the shape given as an example in the Examples. The shape of the heating pad 4 can be any shape such as a shape in which a surface on the fixing region Q5 side is a curved surface.
(H04) An aspect in which the heater 2a that is a heating section is built in the heating roll 2 has been given as an example in the Examples described above, but the present invention is not limited thereto. An aspect in which the heater is built in the heating pad 4 can also be adopted. In addition, the heating roll that comes into contact with the outer surface of the fixing belt 1 can also be disposed. Further, an aspect in which a plurality of heating rolls with built-in heaters or a plurality of heating pads with built-in heaters are installed and one or a plurality of heat sources are operated, that is, an aspect in which a plurality of heat sources are selectively operated can also be adopted.
(H05) In the Examples, for example, an aspect in which the interval L1 and the angles θ1 and θ2 are maintained is desirable, but the present invention is not limited thereto. For example, an aspect in which only the interval L1 is maintained or an aspect in which only the angle θ1 is maintained can also be adopted.
(H06) In the Examples, an aspect in which the peeling baffle 7 has a flat plate shape has been described as an example, but the present invention is not limited thereto. Any shape, such as a wedge shape, a claw shape, or a comb shape, can be used.

### SUPPLEMENTARY NOTES

(((1)))

A fixing device comprising:
a first fixing section that has an endless section that rotates, a support section which is disposed to correspond to a fixing region through which a medium passes and which supports the endless section, and a heating section which heats the fixing region to increase a temperature of the fixing region to a fixing temperature determined in advance;
a second fixing section that has a facing section which is pressed against the support section with the endless section nipped between the facing section and the support section in the fixing region;
a peeling section that is disposed on a downstream side of the fixing region in a transport direction of the medium and that peels off the medium from the endless section;
a changing section that changes a support position of the support section for the endless section according to a type of the medium; and
a moving section that moves the peeling section in accordance with a movement of the support section.
(((2)))

The fixing device according to (((1))),
wherein the fixing device includes the peeling section that has a flat plate shape; and
the moving section that moves the peeling section in accordance with the movement of the support section such that an interval between a tip portion of the peeling section on a fixing region side and the endless section is an interval determined in advance and an angle formed by an extension line of a surface of the support section, which forms the fixing region, and an extension line of the peeling section having the flat plate shape is an angle determined in advance.
(((3)))

The fixing device according to (((2))), further comprising:
a second support section that supports the endless section at a position on a downstream side of the support section in a rotation direction of the endless section,
wherein the fixing device includes the moving section that moves the second support section in accordance with the movement of the support section such that an angle formed by a surface of the endless section between the support section and the second support section and the extension line of the peeling section having the flat plate shape is an angle determined in advance.
(((4)))

The fixing device according to any one of (((1))) to (((3))),
wherein the fixing device includes the moving section that has a biasing section which moves toward the changing section and that moves the peeling section in accordance with the movement of the support section as the moving section is pressed against the changing section.
(((5)))

The fixing device according to any one of (((1))) to (((3))),
wherein the fixing device includes the moving section that connects the peeling section and the support section to each other and that moves the peeling section integrally with the movement of the support section.
(((6)))

The fixing device according to any one of (((1))) to (((3))),
wherein the fixing device includes the moving section that moves the peeling section in accordance with the movement of the support section independently of an operation of the changing section.
(((7)))

The fixing device according to (((6))),
wherein a movement amount of the support section is different from a movement amount of the peeling section.
(((8)))

An image forming apparatus comprising:
an image holding section that holds an image on a surface of the image holding section;
a transfer section that transfers the image on the image holding section to a medium; and
the fixing device according to any one of (((1))) to (((7))) that fixes the image transferred to the medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a first fixing section that has an endless section that rotates, a support section which is disposed to correspond to a fixing region through which a medium passes and which supports the endless section, and a heating section which heats the fixing region to increase a temperature of the fixing region to a fixing temperature determined in advance;
a second fixing section that has a facing section which is pressed against the support section with the endless section nipped between the facing section and the support section in the fixing region;
a peeling section that is disposed on a downstream side of the fixing region in a transport direction of the medium and that peels off the medium from the endless section;
a changing section that changes a support position of the support section for the endless section according to a type of the medium; and
a moving section that moves the peeling section in accordance with a movement of the support section.

2. The fixing device according to claim 1,
wherein the fixing device includes the peeling section that has a flat plate shape; and
the moving section that moves the peeling section in accordance with the movement of the support section such that an interval between a tip portion of the peeling section on a fixing region side and the endless section is an interval determined in advance and an angle formed by an extension line of a surface of the support section, which forms the fixing region, and an extension line of the peeling section having the flat plate shape is an angle determined in advance.

3. The fixing device according to claim 2, further comprising:
a second support section that supports the endless section at a position on a downstream side of the support section in a rotation direction of the endless section,
wherein the fixing device includes the moving section that moves the second support section in accordance with the movement of the support section such that an angle formed by a surface of the endless section between the support section and the second support section and the extension line of the peeling section having the flat plate shape is an angle determined in advance.

4. The fixing device according to claim 1,
wherein the fixing device includes the moving section that has a biasing section which moves toward the changing section and that moves the peeling section in accordance with the movement of the support section as the moving section is pressed against the changing section.

5. The fixing device according to claim 1,
wherein the fixing device includes the moving section that connects the peeling section and the support section to each other and that moves the peeling section integrally with the movement of the support section.

6. The fixing device according to claim 1,
wherein the fixing device includes the moving section that moves the peeling section in accordance with the movement of the support section independently of an operation of the changing section.

7. The fixing device according to claim 6,
wherein a movement amount of the support section is different from a movement amount of the peeling section.

8. An image forming apparatus comprising:
an image holding section that holds an image on a surface of the image holding section;
a transfer section that transfers the image on the image holding section to a medium; and
the fixing device according to claim 1 that fixes the image transferred to the medium.

9. An image forming apparatus comprising:
an image holding section that holds an image on a surface of the image holding section;
a transfer section that transfers the image on the image holding section to a medium; and
the fixing device according to claim 2 that fixes the image transferred to the medium.

10. An image forming apparatus comprising:
an image holding section that holds an image on a surface of the image holding section;
a transfer section that transfers the image on the image holding section to a medium; and
the fixing device according to claim 3 that fixes the image transferred to the medium.

11. An image forming apparatus comprising:
an image holding section that holds an image on a surface of the image holding section;
a transfer section that transfers the image on the image holding section to a medium; and
the fixing device according to claim 4 that fixes the image transferred to the medium.

12. An image forming apparatus comprising:
an image holding section that holds an image on a surface of the image holding section;
a transfer section that transfers the image on the image holding section to a medium; and
the fixing device according to claim 5 that fixes the image transferred to the medium.

13. An image forming apparatus comprising:
an image holding section that holds an image on a surface of the image holding section;
a transfer section that transfers the image on the image holding section to a medium; and
the fixing device according to claim 6 that fixes the image transferred to the medium.

14. An image forming apparatus comprising:
an image holding section that holds an image on a surface of the image holding section;
a transfer section that transfers the image on the image holding section to a medium; and
the fixing device according to claim 7 that fixes the image transferred to the medium.

15. A fixing device comprising:
a first fixing section that has an endless section that rotates, a support section which is disposed to correspond to a fixing region through which a medium passes and which supports the endless section, and a heating section which heats the fixing region to increase a temperature of the fixing region to a fixing temperature determined in advance;
a second fixing section that has a facing section which is pressed against the support section with the endless section nipped between the facing section and the support section in the fixing region;
means for peeling off the medium from the endless section, the means being disposed on a downstream side of the fixing region in a transport direction of the medium;
means for changing a support position of the support section for the endless section according to a type of the medium; and
means for moving the peeling section in accordance with a movement of the support section.
